(19) United States
(12) Patent Application Publication
(10) Pub. No.: US 2026/0111914 A1
(43) Pub. Date: Apr. 23, 2026

(54) SYSTEM AND METHOD FOR VALIDATING COMPLIANCE WITH AVIATION REGULATIONS, INDUSTRY STANDARDS, AND STANDARD OPERATING PROCEDURES

(71) Applicants: Dagmar Andersch, New York, NY (US); Frank Wobith, Beuren (DE); Frank Leonhard, Vienna (AT)

(72) Inventors: Dagmar Andersch, New York, NY (US); Frank Wobith, Beuren (DE); Frank Leonhard, Vienna (AT)

(21) Appl. No.: 19/364,393

(22) Filed: Oct. 21, 2025

Related U.S. Application Data
(60) Provisional application No. 63/709,567, filed on Oct. 21, 2024.

(51) Int. Cl. G06Q 30/018; G06F 40/169; G06F 40/30

(52) U.S. Cl. CPC G06Q 30/018; G06F 40/169; G06F 40/30

(57) ABSTRACT

A system and method for validating aviation regulatory compliance is disclosed. The system employs a method using AI to check aviation document compliance with regulations. It parses documents locally, compares semantically via hybrid AI, identifies gaps, offers remediation options from original texts, updates scores, and generates reports, ensuring efficiency and privacy.

### CROSS-REFERENCE TO RELATED APPLICATIONS

This application claims the benefit of priority to U.S. Provisional Patent Application No. 63/709,567, filed on Oct. 21, 2024, which is incorporated by reference herein in its entirety.

### TECHNICAL FIELD

The present invention relates to aviation regulatory compliance and, more specifically, to a system and method for validating aviation regulatory compliance utilizing artificial intelligence.

### BACKGROUND

The aviation industry faces challenges in ensuring regulatory compliance due to evolving standards from bodies like ICAO, EASA, and FAA. Traditional manual checks are time-consuming and error-prone. This invention provides an AI-driven method to automate compliance scanning, gap detection, and remediation options for aviation documents, using hybrid local-cloud AI processing to enhance efficiency, traceability, and privacy.

Artificial Intelligence (AI) Machine Learning (MI) and Automation have been part of the aviation industry for long, basically since the introduction of the autopilot. New advancements in technology, larger and fast computing capacity and processors, innovation in unmanned aviation and remotely controlled vehicles and many more aspects developing in the aviation industry, are now catapulting the aviation altogether into a new aera of doing business.

AI is omnipresent impacting all aviation areas ranging from aircraft design, production, and maintenance over flight operations to environmental aspects, air traffic management, aerodromes, cyber security and not to forget the limitless possibilities of space exploration and space flight.

### SUMMARY OF THE INVENTION

According to one non-limiting aspect of the present disclosure, an example embodiment of a method for validating aviation regulatory compliance is disclosed. The method includes the steps of: authenticating a user; receiving a user document; selecting a regulatory standard; parsing the document offline using local AI; performing semantic comparison with the standard using hybrid local-cloud AI; identifying compliance gaps; and generating a compliance score.

The method involves user authentication, document upload, selection of regulatory standards, AI-based semantic comparison, non-compliance identification, provision of corrective options, and report generation. It employs local inference for sensitive data and cloud for advanced reasoning, ensuring compliance with aviation regulations while maintaining data security.

According to another non-limiting aspect of the present disclosure, an example embodiment of a system for validating aviation regulatory compliance is disclosed. The system includes: a user interface or front end for carrying out user workflows, checklist runner, and dashboards; a local engine for offline parsing and private checks; a cloud engine for deep reasoning, report drafting, and translation; a data store for storing evidence, vector search, and audit logs; and at least one integration API for exporting and importing from SMS, QMS, and ERP.

### BRIEF DESCRIPTION OF THE DRAWINGS

Features and advantages of the system and method described herein may be better understood by reference to the accompanying drawings in which:

FIG. 1 is a flowchart depicting the steps that of the claimed method that are taken by the claimed system to carry out the overall compliance check process;

FIG. 2 is a flowchart depicting the steps that of the claimed method that are taken by the claimed system to carry out the compliance gap identification and remediation process; and

FIG. 3 depicts a system architecture diagram.

A skilled artisan will appreciate the foregoing details, as well as others, upon considering the following Detailed Description of certain non-limiting embodiments of the device according to the present disclosure. One of ordinary skill also may comprehend certain of such additional details upon using the device described herein.

### DETAILED DESCRIPTION

The present invention relates to aviation regulatory compliance and, more specifically, to a system and method for validating aviation regulatory compliance utilizing artificial intelligence.

Compliance with aviation rules and requirements is the most basic common denominator for aviation safety.

However, the aviation industry is growing at an unprecedented rate. The International Civil Aviation Organization (ICAO) is publishing novel standards for UAS/drones. AI requirements, standards, and other guidance material. Innovations are regular. Many of which require certification, approval, or registration by regulators or other third parties.

Workload is exploding while the number of experienced subject matter experts hardly can fulfill market demand, and the qualification and training of new experts is complex in a field where hands-on experience is key.

The system disclosed herein is a tool that can be used by aviation inspectors, auditors, certifying staff or other aviation experts to facilitate a method for compliance check.

The claimed method provides a healthy balance of man-machine interface in a way that ensures transparency and traceability, so that users remain in control over deciding if compliance is established.

The claimed method supports regulators, airlines, and other aviation industry branches worldwide in performing documentation compliance checks, releasing them from monotonous tasks while freeing additional work capacity.

The claimed method automates aviation compliance using AI. Users access a web-based system to upload documents (e.g., manuals). The claimed system parses offline via local LLM (e.g., Ollama), creates embeddings, and compares semantically with selected standards (e.g., ICAO Annexes). Hybrid sync uses anonymized data for cloud reasoning. Gaps are highlighted; options from original regulatory text are provided for insertion. Scores update in real-time. Actions are logged; data not stored beyond 24 hours. System ensures usability, reliability, performance, security, and maintainability per quality attributes.

The figures depict the claimed method and a system for facilitating the claimed method.

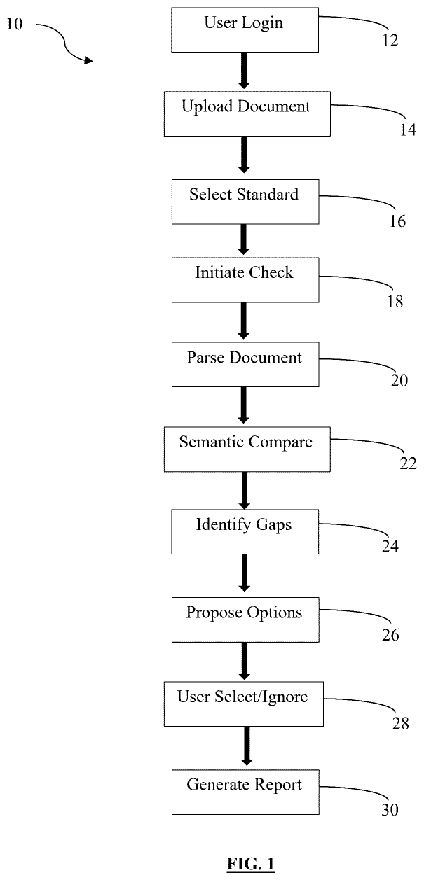

In particular, FIG. 1 depicts a flowchart of the overall compliance check process (reference numeral 10). As shown in FIG. 1, a user starts by logging in (at 12). The user then uploads a document (at 14) and then selects a standard (at 16) in which to check compliance therewith. The user initiates the check (at 18), and the system parses the document (at 20) and then conducts a semantic compare using AI (at 22). The system identifies gaps (at 24) and proposes options to the user (at 26). The user may choose to select or to ignore any of the proposals (at 28). The system then generates a report (at 30) and ends the process.

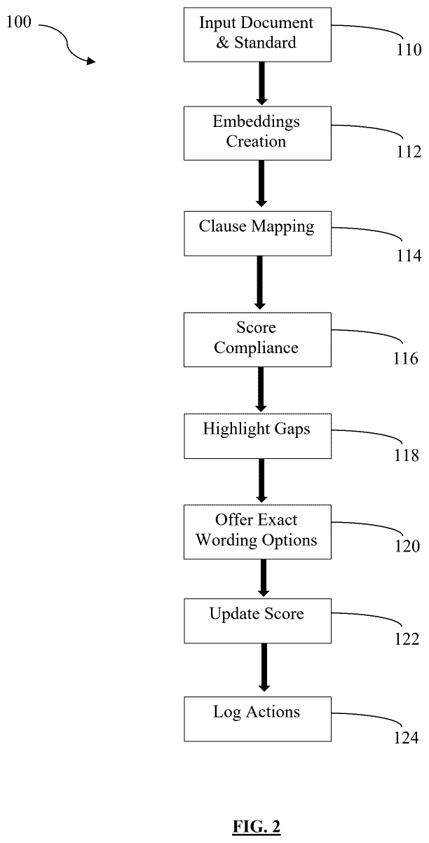

FIG. 2 shows a flowchart of compliance gap identification and remediation (reference numeral 100). As shown in FIG. 2, the user inputs a document and selects the appropriate standard for checking compliance therewith (at 110). The system carries out embeddings creation (at 112) and clause mapping (at 114) across the document to score compliance (at 116). The system then highlights gaps (at 118) and offers exact wording options (at 120), which the user may select or ignore. The system then updates the compliance score (at 122) and logs actions (at 124).

The following set of paragraphs break each of these steps down individually.

### System Feature 1—User Log-in (FIG. 1, at 12)

The user opens a webpage pertaining to the UI. The user chooses-sign-up (new user) or—sign-in (already registered user). The system carries out authentication with two-factor & secure session.

### System Feature 2—Compliance Check Set-up (FIG. 1, at 14, 16)

The user chooses a document that the user wishes to compliance check. The user selects from a UI drop-down menu the aviation rule, requirement, or standards against which the user wishes to perform a compliance check.

### Functional Requirements

System to identify user's document format.
System to identify user's unreadable document format and display invalid input.
User shall not be able to copy or download ACELERO compliance document/rule/requirement/standard.
Ollama (Llama local model or similar)
Parses files offline→identifies structure (titles, sections, revisions, dates).
Creates semantic embeddings for local search.

### System Feature 3—Compliance Check Conduct (FIG. 1, at 18-28)

The system carries out mapping of the rule, regulation, or requirement aiming to match user documentation to regulatory clauses. The user selects a compliance check button in the UI initiating the compliance check conduct of the complete uploaded or selected user document.

### Functional Requirements

System to identify by through highlighting or underlining compliance gap in the user's document.
Cloud/Hybrid Sync (ChatGPT+Ollama, or similar)
Llama detects document content and extracts compliance-relevant text.
ChatGPT cross-references uploaded docs with the correct regulation clauses.

The output of the compliance check is the real-time scoring of the user's compliance status, which may be “compliant”, a warning, or “non-compliant.” The system reviews “non-compliant” or “missing” clauses and drafts proposed results. The user then reviews the proposed results and then edits and/or validates the results.

### System Feature 4—Compliance Check Record (FIG. 1, at 30)

All user actions must be traceable and are documented in a user action log. If the user choses to reverse an action, the system re-establishes the previous document status.

### Functional Requirements

System to identify user's document format.
System to identify user's unreadable document format and display invalid input.
User shall not be able to copy or download ACELERO compliance document/rule/requirement/standard.
Report Builder (Lovable template+ChatGPT synthesis)

### System Feature 5—Security, Privacy & Governance Layer

Local Inference: sensitive content stays within device (Ollama). Cloud Inference: anonymized summaries sent to ChatGPT.

### System Feature 6—Application Display

Total compliance score in percent (%) of the user's document. Total number of non-compliances detected in the user's document. For each non-compliance detected the user can click on the highlighted non-compliance=dialog elements associated with the non-compliance. Drill-down capabilities to view specific non-compliance details.

The system is not judging but comparing. Once the user has clicked on the highlighted text, the system proposes options to the user to establish compliance the user can choose from. Options are exact wordings/phraseology of the rule/requirement/standard the user wants to establish compliance with. The system does not re-phrase or interpret the rule/requirement/standard the user wants to establish compliance with. The user must choose and select which text option to use. Once inserted in the user document the overall compliance score corresponds accordingly.

The system offers an option to the user to “ignore” corrective action, and then the overall compliance score remains unchanged. However, the system offers guidance material and references (found in all rules, requirements/standards in the acelero database) in correlation to the non-compliance identified. this feature provides for background reading material to the user.

While performing compliance checks, the system measures:
Granularity, the level of detail and fineness in data Rose is assessing
Accuracy of data
Completeness of data-number of missing keywords/processes/procedures to establish compliance.
Understandability-according to readability (Flesch-Kincaid test; score 60.0-50.0=100%), language clarity, language being gender neutral, average number of words per sentence, and number of sentences in passive voice.

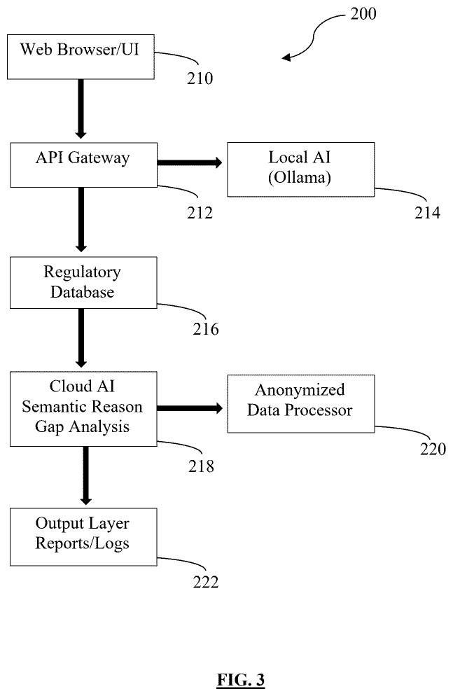

FIG. 3 depicts the system architecture (reference numeral 200). As shown in FIG. 3, the system has a user interface (UI) or front end (at 210) for carrying out user workflows, checklist runner, and dashboards. One example of software for the UI is Lovable.

The system also has a local engine for offline parsing and private checks (at 214). One example of software for the local engine is Ollama.

The system also has a cloud engine for deep reasoning, report drafting, and translation (at 218). One example of software for the cloud engine is ChatGPT, although other artificial intelligence engines may be suitable. The cloud engine (218) utilizes an anonymized data processor (at 220) for processing data.

The system also has a data store for storing regulations, rules, standards, evidence, vector search, and audit logs (at 216). One example of a data store is PostgreSQL+Vector DB.

The system also has integration APIs (at 212) for exporting and importing from SMS, QMS, and ERP. An example of such an API is REST/Webhooks.

With respect to hardware, the system runs on standard web servers and user standard desktop computers and mobile devices.

With respect to software, the system utilizes a web-based application, compatible with modern web browsers (Chrome, Firefox, Edge), and mobile platforms (IOS, Android).

With respect to networking, the system utilizes a secure internet/intranet connection for accessing compliance data.

In use, the claimed system and claimed method provide many advantages. For example, one advantage is greater usability. The user interface is very intuitive and simplifies navigation and task completion. It provides comprehensive documentation and help resources for users and customizable reports tailored to user needs.

Another advantage is reliability. The claimed system and method provide consistent performance under various workloads with minimal downtime. It provides robust error handling and data recovery mechanisms as well as regular backups to prevent data loss.

A further another advantage is performance. The claimed system and method offer fast response times for data retrieval and reporting. It provides for the efficient handling of large datasets, especially during the conduct of the compliance check(s). It provides minimal resource consumption while maintaining responsiveness.

Yet another advantage is security. The claimed system and method provide strong authentication and authorization mechanisms to protect sensitive data. It provides encryption of data both in transit and at rest. It is compliant with industry standards (e.g., ISO 27001) for data protection.

Still yet another advantage is maintainability. The claimed system and method provide clear and well-organized codebase for easier updates and enhancements. It is comprised of a modular architecture allowing for isolated changes and upgrades. It offers comprehensive documentation for developers and maintainers. And it provides the ability to accommodate growing amounts of data and users without performance degradation.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended set of claims.

What is claimed is:

1. A method for AI-supported aviation compliance checking, the method comprising the steps of:
authenticating a user;
receiving a user document;
selecting a regulatory standard;
parsing the document offline using local AI;
performing semantic comparison with the standard using hybrid local-cloud AI;
identifying compliance gaps; and
generating a compliance score.

2. The method of claim 1, further comprising highlighting non-compliances in the user document.

3. The method of claim 1, wherein the local AI uses Ollama or similar for embedding creation without cloud transmission.

4. The method of claim 1, wherein cloud AI uses anonymized text for advanced reasoning.

5. The method of claim 1, further comprising providing exact wording options from the standard to remediate gaps.

6. The method of claim 5, wherein user selection of an option updates the document and compliance score.

7. The method of claim 1, further comprising an option to ignore remediation, maintaining the score.

8. The method of claim 1, wherein the regulatory standard is selected from a hub including ICAO, EASA, or FAA regulations.

9. The method of claim 1, further comprising generating a report in PDF or Word format.

10. The method of claim 1, including role-based access for compliance officers, auditors, or regulators.

11. The method of claim 1, ensuring data privacy by deleting user documents after 24 hours.

12. The method of claim 1, measuring granularity, accuracy, completeness, and understandability during checks.

13. The method of claim 1, using a custom LLM trained on aviation expertise.

14. The method of claim 1, supporting manned, unmanned, civil, and military aviation sectors.

15. The method of claim 1, providing guidance material in original wording without interpretation.

16. The method of claim 1, logging all user actions for traceability.

17. The method of claim 1, handling multiple concurrent users with real-time alerts.

18. The method of claim 1, scalable to other industries like finance.

19. A computer-implemented system executing the method of claim 1.

20. A non-transitory computer-readable medium storing instructions for the method of claim.
